(19) United States
(12) Patent Application Publication
(10) Pub. No.: US 2015/0152516 A1
(43) Pub. Date: Jun. 4, 2015

(54) PEARLITE RAIL, FLASH BUTT WELDING METHOD FOR PEARLITE RAIL, AND METHOD OF MANUFACTURING PEARLITE RAIL

(71) Applicants: Tatsumi Kimura, Tokyo (JP); Minoru Honjo, Tokyo (JP); Shinji Mitao, Tokyo (JP); Mineyasu Takemasa, Tokyo (JP); Ryo Matsuoka, Tokyo (JP); Yuzuru Kataoka, Tokyo (JP)

(72) Inventors: Tatsumi Kimura, Tokyo (JP); Minoru Honjo, Tokyo (JP); Shinji Mitao, Tokyo (JP); Mineyasu Takemasa, Tokyo (JP); Ryo Matsuoka, Tokyo (JP); Yuzuru Kataoka, Tokyo (JP)

(73) Assignee: JFE Steel Corporation, Tokyo (JP)

(21) Appl. No.: 14/396,822

(22) PCT Filed: Apr. 25, 2012
(86) PCT No.: PCT/JP2012/061147

§ 371 Date: Oct. 24, 2014

(51) Int. Cl. C21D 9/04; C21D 6/00; C22C 38/42; C22C 38/26; C22C 38/24; B21B 3/02; C22C 38/04; C22C 38/02; E01B 5/02; B23K 11/04; B23K 11/00; C21D 8/00; C22C 38/22

(52) U.S. Cl. CPC C21D 9/04; C21D 8/005; C21D 6/002; C21D 6/004; C21D 6/005; C21D 6/008; C22C 38/42; C22C 38/26; C22C 38/24; C22C 38/22; C22C 38/04; C22C 38/02; E01B 5/02; B23K 11/04; B23K 11/002; B21B 3/02

(57) ABSTRACT

A pearlite rail contains, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr by mass with the balance being Fe and inevitable impurities, wherein a γ+θ temperature range is 100° C. or lower.

### TECHNICAL FIELD

This disclosure relates to a pearlite rail having little softening in a welding heat-affected zone, high hardness, and high ductility, a flash butt welding method for a pearlite rail, and a method of manufacturing a pearlite rail.

### BACKGROUND

Laden weight in freight transport or mine railways is higher than that in passenger cars so that the axle of freight cars receives a high load, which leads to very severe contact environments between rails and wheels. Since rails for use in such contact environments require wear resistance, steels having a pearlite structure have been conventionally used for the rails.

Recently, the laden weight of cargo, minerals, and the like has been further increasing because of improvement in rail transport efficiency. This causes severe wear of rails and shortens rail life. From such backgrounds, improvement in wear resistance of rails has been needed to improve rail life, and many tough rails having increased hardness have been proposed. For example, Japanese Patent No. 4272385, Japanese Patent No. 3078461, Japanese Patent No. 3081116 and Japanese Patent No. 3513427 describe hypereutectoid rails having increased cementite content, and methods of manufacturing the hypereutectoid rails. In addition, Japanese Patent No. 4390004, Japanese Patent Application Laid-open No. 2009-108396 and Japanese Patent Application Laid-open No. 2009-235515 describe techniques of increasing the hardness of rails by narrowing the lamellar intervals of the pearlite structure of eutectoid carbon steels.

To increase the hardness of rails and also prevent breakage of rails on the basis of surface defects in rail heads and feet, it is also important to increase the ductility of rails. As measures to improve the ductility of rails, Japanese Patent Application Laid-open No. 2008-50687 and Japanese Patent No. 3113137 have proposed controlled rolling. Needless to say, rails require good fatigue strength.

By the way, rails are cut into certain lengths and shipped to customers. Rails are then connected at rail joints by shop weldings such as flash butt welding and gas pressure welding, and site weldings such as enclosed welding and thermite welding at the customer side to produce long rails. This reduces vibration and noise which occur at rail joints. For this reason, in addition to the hardness, fatigue strength, and ductility of rail base materials, the hardness, fatigue strength, and ductility of welds between rails (rail welds) are also important factors to prevent damage to the rail welds.

Japanese Patent Application Laid-open No. 2007-289970 has proposed the technique focusing on the hardness of such rail welds. That technique involves optimizing a flash butt welding method and welding conditions to suppress softening in a rail part affected by welding heat (welding heat-affected zone) and reduce uneven wear of rails, which are related to the welding conditions.

The technique described in Japanese Patent Application Laid-open No. 2007-289970 relates to a welding technique, but not a technique of examining a rail base material suitable to increase the hardness of rail welds.

Although many studies have been made to improve the wear resistance of rails as mentioned above, there are few studies focusing on the hardness of rail welds, particularly soften parts of welding heat-affected zones, together with an increase in the hardness and improvement in the ductility of rail base materials.

It could therefore be helpful to provide a pearlite rail having little softening in a welding heat-affected zone, high hardness, and high ductility, a flash butt welding method for a pearlite rail, and a method of manufacturing a pearlite rail.

### SUMMARY

We thus provide:

A pearlite rail contains, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr by mass with the balance being Fe and inevitable impurities, wherein a γ+θ temperature range is 100° C. or lower.

The above-described pearlite rail may further contain at least one of 0.01 to 1.0% Cu, 0.01 to 0.5% Ni, 0.01 to 0.5% Mo, 0.001 to 0.15% V, and 0.001 to 0.030% Nb with the balance being Fe and inevitable impurities, wherein the γ+θ temperature range is 100° C. or lower.

The pearlite rail may contain, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr by mass with the balance being Fe and inevitable impurities, wherein a γ+θ temperature range is 100° C. or lower, and in a welding heat-affected zone formed by flash butt welding where a residence time in a γ+θ temperature region is 200 s or less, a softened part with a Vickers hardness of 300 HV or less has a width of 15 mm or less, and a most softened part has a hardness of 270 HV or more.

The above-described pearlite rail may further contain at least one of 0.01 to 1.0% Cu, 0.01 to 0.5% Ni, 0.01 to 0.5% Mo, 0.001 to 0.15% V, and 0.001 to 0.030% Nb with the balance being Fe and inevitable impurities, wherein the γ+θ temperature range is 100° C. or lower, and in a welding heat-affected zone during welding, a softened part with a Vickers hardness of 300 HV or less has a width of 15 mm or less, and a most softened part has a hardness of 270 HV or more.

The proportion of the number of cementites with a ratio of a longer side to a shorter side (aspect ratio) of 5 or less is 50% or less based on a total cementite amount in a most softened part in a welding heat-affected zone.

In a flash butt welding method for a pearlite rail, during upsetting and subsequent cooling in a flash butt welding of a pearlite rail, a residence time in a γ+θ temperature region is 200 s or less, a softened part of a welding heat-affected zone has a width of 15 mm or less, and a most softened part has a hardness of 270 HV or more.

A method of manufacturing a pearlite rail uses a rail material having the chemical composition as defined above and includes: starting accelerated cooling from a temperature of 720° C. or higher after hot rolling; accelerating cooling at a cooling rate of 1° C./s to 10° C./s to reach 500° C. or lower; and then allowing to cool to recover a temperature of a rail surface to 400° C. or higher.

Moreover, a method of manufacturing a pearlite rail uses a rail material having the chemical composition as defined in the above-described invention and includes: performing hot rolling with a reduction of area of 20% or more at 1,000° C. or lower and with a roll finishing temperature of 800° C. or higher; subsequently starting accelerated cooling from 720° C. or higher; accelerating cooling at a cooling rate of 1° C./s to 10° C./s to reach 500° C. or lower; and then allowing to cool to recover a temperature of a rail surface to 400° C. or higher.

In the method, the manufactured pearlite rail may have a rail head surface with a hardness of 370 HV or more, a tensile strength of 1300 MPa or more, and a 0.2% yield strength of 827 MPa or more.

In the method, the manufactured pearlite rail may have a rail head surface with a hardness of 370 HV or more, a tensile strength of 1300 MPa or more, a 0.2% yield strength of 827 MPa or more, and an elongation of 10% or more.

We can thus provide a pearlite rail having little softening in a welding heat-affected zone, high hardness, and high ductility, a flash butt welding method for a pearlite rail, and a method of manufacturing a pearlite rail.

### BRIEF DESCRIPTION OF THE DRAWINGS

FIG. 1 is a figure illustrating an Fe—C phase diagram of Fe—C-0.5Si—0.7Mn-0.2Cr steel.

FIG. 2 is a figure illustrating the relationship between the maximum attained temperature and the hardness in the results of a thermal cycling test.

FIG. 3 is a figure illustrating the relationship between the γ+θ temperature range and the temperature range in which the hardness is 300 HV or less in the results of the thermal cycling test.

FIG. 4 is a figure illustrating the relationship of the cementite spheroidization rate and the maximum attained temperature.

FIG. 5 is a figure illustrating the relationship between the residence time in the γ+θ temperature region and the hardness of the most softened part in the welding heat-affected zone.

FIG. 6 is a figure illustrating the relationship between the residence time in the γ+θ temperature region and the softening width of the welding heat-affected zone with a hardness of 300 HV or less.

### DETAILED DESCRIPTION

An example will be specifically described below with reference to the drawings. It should be understood that the disclosure is not limited by the example.

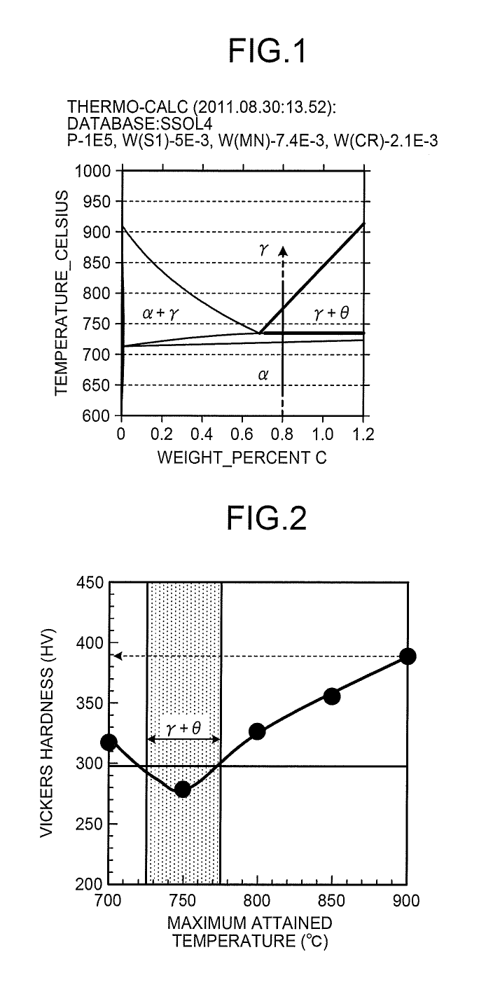

First, we specifically studied the hardness of rail welds and structural changes thereof. FIG. I illustrates an Fe—C phase diagram of Fe—C-0.5Si—0.7Mn-0.2Cr steel (Source: B. Jansson, M. Schalin, M. Selleby and B. Sundman: Computer Software in Chemical and Extractive Metallurgy, ed. By C. W. Bale et al., (The Metall. Soc. CIM, Quebec, 1993), 57-71). With reference to FIG. 1, structural changes due to temperature rise associated with welding are described below for a rail base material containing 0.8% C which exhibits a pearlite structure.

(1) At temperatures of not higher than about 720° C. at which the transformation of ferrite (α) to austenite (γ) begins, the pearlite structure is substantially maintained.

(2) Over 720° C., ferrite (α) is being transformed to austenite (γ), entering a temperature region in which three phases of ferrite (α), cementite (θ), and austenite (γ) coexist.

(3) As the temperature further increases to 730° C. or higher, two phases of cementite (θ) and austenite (γ) coexist. Since the shape of rod-like cementite (θ) is changed so as to reduce surface energy with rising temperature associated with welding, cementite (θ) is divided and spheroidized in parts which are heated to a two-phase temperature region composed of austenite (γ) and cementite (θ).

(4) At higher temperatures, an austenite (γ) single phase exists.

(5) At still higher temperatures, melting occurs.

Although joints are heated by welding to the melt temperature or more (i.e., (5)), the temperature rise associated with welding decreases with distance from the joints in welding heat-affected zones, and the microstructure changes from (4)→(3)→(2)→(1) where the pearlite structure is maintained, depending on the maximum attained temperature of each part.

In consideration of softening of the rail weld, changes in the microstructure depend on the maximum attained temperature associated with welding as described above. It is accordingly necessary to consider structures at the maximum attained temperature during welding and after subsequent cooling. Therefore, a thermal cycling test to examine the effect of heat history during welding on changes in the microstructure and the hardness thereof was carried out using a reproducible thermal cycling machine capable of freely changing the maximum attained temperature and subsequent cooling. Specifically, the maximum attained temperature was changed for the pearlite rail of 0.8% C-0.55% Si-0.7% Mn-0.2% Cr system.

After the temperature of the rail weld reaches the maximum attained temperature, the rail is cooled by air blast cooling to suppress softening of the rail weld. As the cooling rate during the air blast cooling was 1 to 3° C./s, the rail was cooled at a cooling rate of 1° C./s, which corresponded to the lower limit of the cooling rate after the welding, to examine the relationship between the maximum attained temperature and changes of the hardness (Vickers hardness) and cementite (θ). The results are shown in FIG. 2. As shown in FIG. 2, the rail was most softened when the maximum attained temperature increased to the temperature at which two phases of cementite (θ) and austenite (γ) exist (γ+θ temperature) as described above in (3). Heated rail structures ((a): unheated base material, (b): structure heated to the maximum attained temperature of 700° C., (c): structure heated to the maximum attained temperature of 750° C., and (d): structure heated to the maximum attained temperature of 800° C.) were observed with SEM. The cementite phase in the pearlite structure (laminated structure composed of ferrite and cementite) was found to be significantly spheroidized in the 750° C.-heated structure (c). In other words, the softening in FIG. 2 means that cementite (θ) in a non-solid solution state was changed to a stable spherical form, and the hardness of the spherical cementite (θ) decreases in order that the spherical cementite (θ) remains as it is even after cooling.

When the maximum attained temperature was increased to a high temperature at which an austenite (γ) single phase exists, it formed a pearlite structure having a fine lamellar structure composed of ferrite (α) and cementite (θ) during subsequent cooling to increase the hardness of the rail weld.

On the contrary, even when the maximum attained temperature was below the γ+θ temperature, the base material basically kept the pearlite structure so that a decrease in the hardness was small. In other words, the area heated by welding to the γ+θ temperature region in the Fe—C phase diagram illustrated in FIG. 1 corresponds to the most softened part where cementite (θ) is spheroidized.

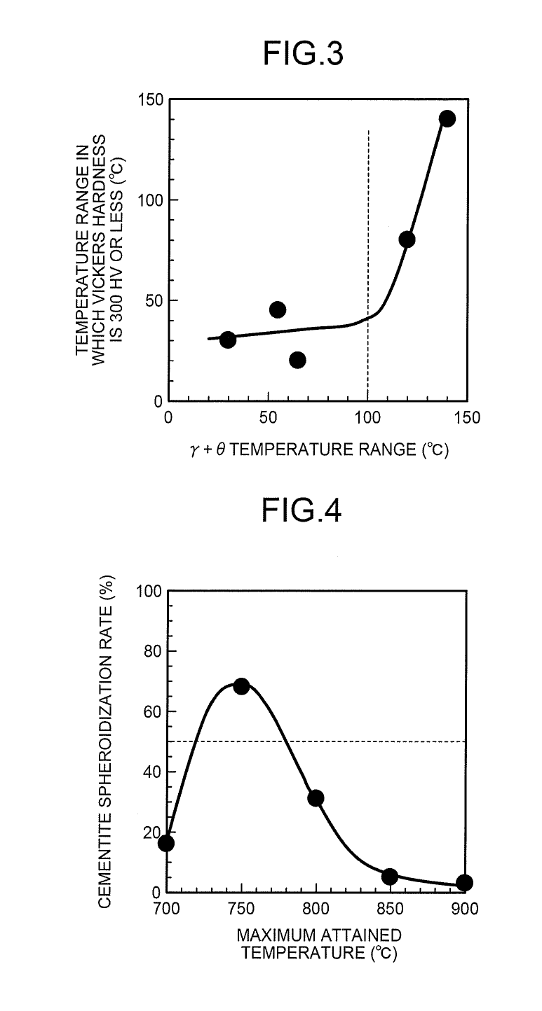

Next, focusing on the temperature range of the γ+θ temperature region (γ+θ temperature range) for steels containing certain C contents based on our new findings, the thermal cycling test as described above was carried out to investigate softening of the welding heat-affected zone using steels with varying carbon contents in the Fe—C phase diagram of Fe—C-0.5Si-0.7Mn-0.2Cr steel in FIG. 1. FIG. 3 illustrates the results where the abscissa represents the γ+θ temperature range and the ordinate represents the temperature range in which the Vickers hardness is 300 HV or less (in the thermal cycling test assuming heat history during welding). As illustrated in FIG. 3, when the γ+θ temperature range exceeded 100° C., the temperature range in which cementite (θ) was spheroidized extended so that the temperature range in which the welding heat-affected zone was softened extended.

Based on the results in FIGS. 2 and 3, the softening of the welding heat-affected zone was analyzed from the spheroidization behavior of cementite. The spheroidization rate of cementite was quantified by defining the spheroidization rate as follows. The microstructure of the welding heat-affected zone was observed at a magnification of 10,000× or greater with a scanning electron microscope (SEM). With regard to the shape of cementite, the number (A) of relatively spherical cementites having a length-to-width ratio (aspect ratio) of 5 or less was counted. The proportion of the number (A) to the total cementite number (B) was obtained on the basis of the formula (C) below and defined as the cementite spheroidization rate.

Spheroidization rate=Number (A) of cementites having an aspect ratio of 5 or less/Total cementite number (B)×100 (C)

The target cementite number is 100 or more, or the field of view is 100 μm² or more.

FIG. 4 illustrates the relationship between the cementite spheroidization rate and the maximum attained temperature. As illustrated in FIG. 4, the softening range shown in FIG. 2 corresponds to the region where the spheroidization rate of cementite exceeds 50%. In other words, the detailed study results as described above indicate the +0 temperature range over 100° C. significantly accelerates the spheroidization of cementite to reduce the hardness of the welding heat-affected zone severely.

Next, the limited ranges of the amounts of chemical components in the rail and the temperature r+θ and the reason for the limitation will be described below. The units of the amounts of the following chemical components are expressed in percent by mass (mass %).

### C: 0.70 to 1.0%

C is an important element to form cementite in pearlite rails to increases the hardness and strength and thereby improve wear resistance. However, such effects are small with the C content below 0.70%, and thus the lower limit of the C content is 0.7%. In contrast, an increase in the C content means an increase in the cementite content, which expectedly increases the hardness and strength but conversely decreases the ductility. Moreover, the increase in the C content extends the γ+θ temperature range to promote softening of the welding heat-affected zone. In consideration of these adverse effects, the upper limit of the C content was 1.0%. The C content preferably ranges from 0.70 to 0.95%.

### Si: 0.1 to 1.5%

Si is added to the rail base material as a deoxidant and for pearlite structure reinforcement. These effects, however, are small with the Si content below 0.1%. In contrast, addition of Si over 1.5% easily causes joint defects during welding, accelerates surface decarburization, and also easily generates martensite in the rail base material. Therefore, the upper limit of the Si content was 1.5%. The Si content preferably ranges from 0.2 to 1.3%.

### Mn: 0.01 to 1.5%

Mn is an effective element to keep high hardness even inside rails because of the effect of decreasing the pearlite transformation temperature to narrow the pearlite lamellar intervals (lamellar intervals in the pearlite structure). The effect, however, is small with the Mn content below 0.01%. In contrast, addition of Mn over 1.5% decreases the equilibrium transformation temperature (TE) of pearlite and also easily causes the martensite transformation. Therefore, the upper limit of the Mn content is 1.5%. The Mn content preferably ranges from 0.3 to 1.3%.

### P: 0.001 to 0.035%

The P content over 0.035% reduces ductility. The upper limit of the P content is accordingly 0.035% or less. The upper limit of the P content as an optimum range is 0.025%. Meanwhile, with regard to the lower limit of the P content, special refinements and the like increase the cost for smelting, and thus the lower limit of the P content is 0.001%.

### S: 0.0005 to 0.030%

S forms coarse MnS extending in the rolling direction to reduce ductility and delayed fracture properties. The coarsening of MnS accelerates and the number of MnS increases with increasing S content. In consideration of these, the upper limit of the S content was set to 0.030%. With regard to the lower limit of the S content, the cost rise of smelting such as longer smelting time, is significant, and thus the lower limit of the S content is 0.0005%. The S content preferably ranges from 0.001 to 0.020%.

### Cr: 0.1 to 2.0%

Cr increases the equilibrium transformation temperature (TE) and contributes to narrow the pearlite lamellar intervals to increase the hardness and strength. For this, addition of 0.1% Cr or more is required. However, addition of Cr over 2.0% increases occurrence of weld defects (reduces weldability) and increases the hardenability to accelerate formation of martensite. Therefore, the upper limit of the Cr content is 2.0%. The Cr content preferably ranges from 0.2% to 1.5%.

Next, at least one of 0.01 to 1.0% Cu, 0.01 to 0.5% Ni, 0.01 to 0.5% Mo, 0.001 to 0.15% V, and 0.001 to 0.030% Nb can be further added to the above chemical composition.

### Cu: 0.01 to 1.0%

Cu is an element capable of achieving much higher hardness by solid solution strengthening. However, to expect this effect, addition of 0.01% Cu or more is required. However, addition of Cu over 1.0% easily causes surface cracks during continuous casting and rolling. Therefore, the upper limit of the Cu content is 1.0%. The Cu content more preferably ranges from 0.05 to 0.6%.

### Ni: 0.01 to 0.5%

Ni is an effective element to improve the toughness and ductility. Ni is also an effective element to suppress cracks of Cu when added together with Cu, and thus Ni is desirably added when Cu is added. It is noted that the Ni content below 0.01% is insufficient to achieve these effects, and therefore the lower limit of the Ni content is 0.01%. However, addition of Ni over 0.5% increases the hardenability and accelerates generation of martensite, and therefore the upper limit of the Ni content is 0.5%. The Ni content more preferably ranges from 0.05 to 0.3%.

### Mo: 0.01 to 0.5%

Mo is an effective element to increase the strength. However, the effect is small with the Mo content below 0.01% and thus the lower limit of the Mo content is 0.01%. In contrast, addition of Mo over 0.5% generates martensite as a result of increased hardenability, thereby significantly reducing the toughness and ductility. For this reason, the upper limit is 0.5%. The Mo content preferably ranges from 0.05 to 0.3%.

### V: 0.001 to 0.15%

V, which forms VC or VN and finely precipitates in ferrite, is an effective element to increase the strength through precipitation strengthening of ferrite. V also functions as hydrogen trap sites and also can have the effect of suppressing delayed fractures. To achieve these effects, addition of 0.001% V or more is required. However, addition of V over 0.1% saturates such effects while significantly increasing alloy cost and, therefore, the upper limit of the V content is 0.15%. The V content preferably ranges from 0.005 to 0.12%.

### Nb: 0.001 to 0.030%

Nb, which increases the non-recrystallization temperature of austenite, is an element effective to make fine the size of pearlite colonies and blocks by introducing working strain into austenite during rolling, and effective to improve the ductility. To expect such effects, addition of 0.001% Nb or more is required. However, addition of Nb over 0.030% forms crystals of Nb carbonitride in the solidification process to reduce the cleanliness, and therefore the upper limit of the Nb content is 0.030%. The Nb content preferably ranges from 0.003 to 0.025%.

The balance of the composition except for the above-mentioned chemical components includes Fe and inevitable impurities. The amounts of P and S among inevitable impurities are described above. The N content up to 0.015%, the 0 content up to 0.004%, and the H content up to 0.0003% are acceptable. The Al content is desirably 0.001% or less and the Ti content is also desirably 0.001% or less.

γ+θ temperature range is 100° C. or lower:

The γ+θ temperature range over 100° C. accelerates spheroidization of cementite during the flash butt welding of the rail to decrease the hardness of the most softened part in the welding heat-affected zone to 270 HV or less and also to enlarge the softening width of the part where the hardness is 300 HV or less. For these reasons, the γ+θ temperature range needs to be 100° C. or lower. Although the lower limit of the γ+θ temperature range is not particularly specified, the γ+θ temperature range of lower than 10° C. decreases the hardness and strength of the rail base material. Therefore, the lower limit of the γ+θ temperature range is desirably 10° C. The γ+θ temperature range is preferably from 10 to 90° C. With regard to the γ+θ temperature range, the Fe—C equilibrium phase diagram according to the component system is made by a calculation tool such as “Thermo-talc,” a thermodynamic equilibrium calculation tool, to obtain the γ+θ temperature and the γ+θ temperature range. The state of cementite spheroidization may be optionally examined by a thermal cycling test.

Next, the limited range of the hardness of the rail weld and the reason for the limitation will be described.

The hardness of the most softened part of the rail weld is 270 HV or more, and the softening width of the welding heat-affected zone with a hardness of 300 HV or less is 15 mm or less:

Wear and rolling contact fatigue are generated in rail heads by rolling contact of rail heads with wheels. During rolling contact, both rail base materials and rail welds contact with wheels, causing wear and rolling contact fatigue in the both. When the range of softening or the soften part of/in the welding heat-affected zone is large in the rail weld, the softened part is worn out quickly with respect to the rail base material (uneven wear). This generates a difference in wear between the rail base material and the softened part in the welding heat-affected zone so that depressions are formed by wear in the part most softened (the most softened part) in the soft welding heat-affected zone to increase noise and vibration. Furthermore, breakage is also concerned. Accordingly, the softening of the welding heat-affected zone is desirably as small as possible. However, in addition to the most softened part in the welding heat-affected zone as metallurgically described above, parts heated to austenite (γ) and cementite (θ) during welding always exist, and thus it is difficult to completely eliminate the softened part. However, when the hardness of the most softened part of the rail weld is 270 HV or more, and the width of the softened part (softening width) in the welding heat-affected zone with a hardness of 300 HV or less is 15 mm or less, uneven wear of the soften part with respect to the rail base material of the rail weld decreases to reduce noise and vibration. From this, the hardness of the most softened part of the weld is 270 HV or more, and the softening width of the welding heat-affected zone with a hardness of 300 HV or less was set to 15 mm or less.

With respect to the cementite in the most softened part in the welding heat-affected zone, the proportion of the cementite with a ratio of the shorter side to the longer side (aspect ratio) of 5 or less is 50% or less based on the total cementite amount:

Since the cementite in the part maintained in the γ+θ temperature region by heating during welding is spheroidized to enlarge softening and its softening width, the proportion of the number of cementites with a ratio of the shorter side to the longer side (aspect ratio) of 5 or less needs to be 50% or less based on the total cementite amount.

Next, assuming the spheroidization of cementite depends on the residence time in the γ+θ temperature region during welding, the residence time in the γ+θ temperature region during welding by flash butt welding was varied as described below to investigate the softening behavior of the welding heat-affected zone.

As a test material, a rail of Fe-0.8% C-0.5% Si-0.5% Mn-0.77% Cr steel (γ+θ temperature: 750° C. to 815° C., γ+θ temperature range: 65° C.) was used. The time until the temperature reaches the γ+θ temperature or less during the final heating time (Final FLASH), upset time (UP SET), and subsequent cooling in flash butt welding was integrated and defined as the residence time in the γ+θ temperature region. The rail which was flash-butt welded in this manner was measured for the hardness distribution of the rail head at 5 mm below the rail surface at 5 mm longitudinal pitch. The hardness of the most softened part in the welding heat-affected zone and the softening width of the welding heat-affected zone with a hardness below 300 HV were determined for each welding condition to obtain the relationship thereof against the residence time in the γ+θ temperature region during welding.

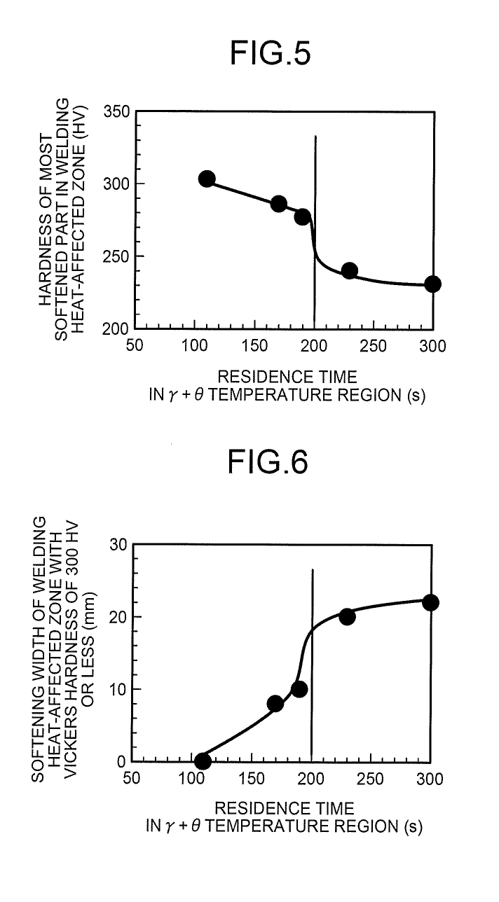

FIG. 5 illustrates the relationship between the residence time in the γ+θ temperature region and the hardness of the most softened part in the welding heat-affected zone. FIG. 6 illustrates the relationship between the residence time in the γ+θ temperature region and the softening width of the welding heat-affected zone with a Vickers hardness of 300 HV or less. As illustrated in FIGS. 5 and 6, when the residence time in the γ+θ temperature region exceeds 200 s, the hardness of the most softened part in the welding heat-affected zone decreases to 270 HV or less, and the softening width with 300 HV or less increases to more than 15 mm, indicating rapid significant softening of the welding heat-affected zone. For this reason, to reduce softening of the welding heat-affected zone as little as possible, the residence time in the γ+θ temperature region during flash butt welding needs to be 200 s or less. Although there is no particular limitation on the lower limit of the residence time in the γ+θ temperature region, the residence time of 30 s or more in the γ+θ temperature region is required to joint rails without any weld defects.

Next, a method of manufacturing a rail will be described below along with the limited conditions and the reason for the limitation. The rail needs to undergo the following procedures: starting accelerated cooling from a temperature of 720° C. or higher after hot rolling; accelerating cooling at a cooling rate of 1° C./s to 10° C./s to reach 500° C. or lower; and then allowing to cool to recover the temperature of the rail surface to 400° C. or higher.

Start accelerated cooling from a temperature of 720° C. or higher:

After hot rolling, accelerated cooling needs to start from a temperature of 720° C. or higher. Accelerated cooling from a temperature below 720° C. decreases the degree of supercooling (ΔT) to reduce the hardness and strength. Accordingly, the starting temperature of the accelerated cooling needs to be 720° C. or higher. The starting temperature of the accelerated cooling is preferably 730° C. or higher.

Cooling Rate 1° C./s to 10° C./s:

The accelerated cooling needs to be carried out at a cooling rate of 1° C./s to 10° C./s. The cooling rate below 1° C./s raises the pearlite transformation temperature to decrease the degree of supercooling (ΔT) so that the pearlite lamellar interval becomes wider to reduce the hardness and strength. In contrast, the cooling rate over 10° C./s easily generates martensite on the rail surface to reduce the ductility and fatigue strength. For this reason, the cooling rate needs to be 1 to 10° C./s. The cooling rate preferably ranges from 1.5° C./s to 7° C./s.

Cooling Stop Temperature 500° C. Or Lower:

The cooling stop temperature in the accelerated cooling needs to be 500° C. or lower. The cooling stop temperature over 500° C. means that accelerated cooling stops in the middle of pearlite transformation and, in particular, the hardness inside the rail significantly decreases. For this reason, the cooling stop temperature needs to be 500° C. or lower. Although the lower limit of the cooling stop temperature is not particularly specified, accelerated cooling to 250° C. or lower is avoided to prevent the martensite transformation. Therefore, the cooling stop temperature desirably ranges from 500° C. to 250° C.

After the accelerated cooling to 500° C. or lower, the rail is allowed to cool to recover the temperature of the rail surface to 400° C. or higher:

After the accelerated cooling to 500° C. or lower, the rail needs to be allowed to cool to recover the temperature of the rail surface to 400° C. or higher. When the recovered temperature of the rail surface is below 400° C., martensite is generated in part of the top surface layer of the rail to reduce the fatigue strength. Therefore, the recovered temperature of the rail surface needs to be 400° C. or higher.

These specified conditions of the accelerated cooling are required for forming the pearlite structure having a fine lamellar structure to provide the rail base material with high hardness and thus to improve the wear resistance of the rail base material.

Specified requirements on the rolling conditions will be described below. When rails are produced by hot rolling using rail materials, the hot rolling needs to be carried out with a reduction of area of 20% or more at 1,000° C. or lower and with a roll finishing temperature of 800° C. or higher.

Reduction of Area of 20% or More at a Rolling Temperature of 1,000° C. Or Lower:

Rails are usually rolled by hot rolling with break down mills, roughing mills, and finishing mills. When rails are rolled at a reduction of area of 20% or more at 1,000° C. or lower in the rolling process with roughing mills and finishing mills, it makes fine the size of pearlite blocks and colonies to expect further improvement in the ductility. In the rolling at a reduction of area of 20% or more at 1,000° C. or higher, and the rolling at a reduction of area of less than 20% even at 1,000° C. or lower, the size of pearlite blocks and colonies is not fine enough to improve the ductility of the rail base material.

Roll Finishing Temperature 800° C. Or Higher:

The roll finishing temperature needs to be 800° C. or higher. The roll finishing temperature below 800° C. decreases the cooling start temperature in the subsequent accelerated cooling so that formation of the pearlite structure having a fine lamellar structure is insufficient, leading to decreased hardness and strength. Therefore, the roll finishing temperature needs to be 800° C. or higher. The roll finishing temperature is desirably 850° C. or higher.

The cooling after such hot rolling follows the aforementioned cooling conditions to provide the rail base material having excellent ductility as well as high hardness and high strength maintained.

Next, the hardness and strength characteristics of the rail head will be described below along with the specified conditions and the reason for the specification.

Hardness of rail surface 370 HV or more:

In rail heads, delamination damage associated with occurrence and propagation of surface cracks are caused by wear and rolling contact fatigue due to contact with wheels. In particular, a lower hardness of the rail surface reduces the wear resistance. In railways mainly for mine railways and freight railways, high stress is applied to rails so that the wear loss increases to reduce rail life. Since the rail wear is significant at a hardness of the rail surface below 370 HV, the hardness of the rail surface needs to be 370 HV or more. The hardness of the rail surface is preferably 380 HV or more.

Tensile Strength 1300 MPa or More:

Basically, the tensile strength at 0.5-inch depth corresponds with the hardness, and the tensile strength needs to be 1300 MPa or more to improve the wear resistance of the rail.

0.2% Yield Strength 827 MPa or More:

The 0.2% yield strength at 0.5-inch depth needs to be 827 MPa or more. When microscopic sliding is generated by the contact of rails with wheels, plastic flow occurs in the top surface layer of rails. Since rails may be damaged by occurrence of cracks and propagation thereof in/from the plastic flow layer, plastic flow needs to be suppressed as low as possible. To do so, the 0.2% yield strength of the rail is preferably higher, and needs to be 827 MPa or more. Moreover, the 0.2% yield strength is also desirably higher against rolling contact fatigue, and the yield strength of 827 MPa or more allows sufficient fatigue strength of the rail for heavy freight transport.

Elongation 10% or More:

Formation and growth of fatigue cracks may lead to serious accidents of rail fractures. To suppress such fractures, the ductility (elongation) is desirably higher. However, both high hardness and high ductility need to be achieved to improve the durability of the rail having a pearlite structure. In high hardness pearlite rails installed in railways such as railways for heavy freight transport and which emphasize on wear resistance, an elongation of 10% or more is sufficient to suppress most of serious accidents. To achieve both high hardness and high ductility with an elongation of 10% or more, advanced manufacturing conditions are employed, for example, controlled rolling is employed in a hot rolling process.

As described above, the pearlite rail, the flash butt welding method for the pearlite rail, and the method of manufacturing the pearlite rail can provide the pearlite rail that has little softening in the welding heat-affected zone, high hardness, and high ductility, the flash butt welding method for the pearlite rail, and the method of manufacturing the pearlite rail.

The above example is illustrative only and this disclosure is not limited thereto. It is apparent from the above description that various modifications according to specifications or the like fall within the scope of the appended claims, and various other examples can be further made within the scope of the appended claims.

### EXAMPLES

A molten steel obtained by smelting in predetermined smelting processes (converter-RH degassing) and alloy adjustment was made into blooms having the chemical compositions shown in Table 1 by continuous casting. The obtained blooms were subjected to hot rolling and accelerated cooling to manufacture rails with high hardness. The manufactured rails were measured for the Vickers hardness of the surface, while tensile test specimens were collected from the rail heads at 10-mm depth and subjected to a tensile test. Microscope samples were collected, and the areas near the rail surface and 0.5-inch depth parts were microscopically observed and the structures thereof were observed under a scanning electron microscope.

TABLE 1

| | | | | | | | | | | | | γ + θ | |
|---|---|---|---|---|---|---|---|---|---|---|---|---|---|
| | | | | | | | | | | | | Temper- | |
| | | | | | | | | | | | | ature | |
| Steel | C | Si | Mn | P | S | Cr | Cu | Ni | Mo | V | Nb | range | Notes |
| A | 0.80 | 0.25 | 0.99 | 0.012 | 0.011 | 0.15 | | | | | | 35 | Example |
| B | 0.77 | 0.54 | 0.67 | 0.011 | 0.010 | 0.21 | | | | | | 30 | Example |
| C | 0.84 | 0.55 | 0.67 | 0.011 | 0.006 | 0.21 | | | | | | 55 | Example |
| D | 0.95 | 0.56 | 0.68 | 0.014 | 0.012 | 0.22 | | | | | | 95 | Example |
| E | 0.98 | 0.54 | 0.65 | 0.012 | 0.010 | 0.20 | | | | | | 105 | Comparative |
| | | | | | | | | | | | | | Example |
| F | 1.01 | 0.56 | 0.68 | 0.014 | 0.012 | 0.22 | | | | | | 135 | Comparative |
| | | | | | | | | | | | | | Example |
| G | 1.10 | 0.25 | 0.22 | 0.018 | 0.008 | 0.76 | | | | | | 145 | Comparative |
| | | | | | | | | | | | | | Example |
| H | 0.82 | 0.55 | 1.15 | 0.018 | 0.011 | 0.23 | | | | | 0.011 | 55 | Example |
| I | 0.80 | 0.51 | 0.54 | 0.018 | 0.008 | 0.75 | | | | 0.055 | | 65 | Example |
| J | 0.82 | 0.92 | 0.65 | 0.015 | 0.011 | 0.22 | | | | | | 50 | Example |
| K | 0.79 | 0.61 | 1.15 | 0.018 | 0.010 | 0.24 | 0.24 | 0.12 | | | | 55 | Example |
| L | 0.83 | 0.55 | 1.10 | 0.015 | 0.012 | 0.25 | | | 0.18 | | | 55 | Example |

Moreover, the rails were joined together by flash butt welding to investigate the hardness characteristics of the joints. The flash butt welding involved straight flashing for 15 s, preheating for 50 s, and subsequent about 20-mm upsetting with the final flashing for 10 s and the upset time of 10 s as standard conditions, followed by allowing to stand for 50 s and subsequent accelerated cooling. Since it was difficult to measure the temperature during rail welding, the residence time in the γ+θ temperature region was defined as the time from preheating to final flashing, upsetting, and subsequent cooling start. The residence time in the γ+θ temperature region was then varied to investigate changes in the hardness of the rail weld. The rail head was cut in the rolling direction and polished, and the welded member for a Vickers hardness test was collected. The Vickers hardness of 1-mm depth parts of the rail head was measured from the rail weld at 1 mm pitch in about 100 mm distance to obtain the hardness of the most softened part in the welding heat-affected zone and the softening width of the softened part with a Vickers hardness below 300 HV. With regard to the most softened part in the rail weld, the microstructure of the welding heat-affected zone was observed at a magnification of 10,000× or higher with a scanning electron microscope (SEM). With regard to the shape of cementite, the number of relatively spherical cementites (A) having a length-to-width ratio (aspect ratio) of 5 or less was counted. The proportion of the number of cementites (A) to the total cementite amount (B) was obtained based on the formula (C) above and defined as the cementite spheroidization rate. It is noted that 100 or more target cementites were randomly measured to obtain the cementite spheroidization rate.

### Example 1

Table 2 shows the hardness of the most softened part in the welding heat-affected zone, the softening width with 300 HV or less, and the cementite spheroidization rate of the most softened part, in the rails having the chemical compositions of steel A to steel K in Table 1 after the flash butt welding. As shown in Table 2, the steels with the γ+θ temperature range over 100° C. (Comparative Examples) exhibit lower hardness of the most softened part in the welding heat-affected zone and also have a wider softening width of the welding heat-affected zone with 300 HV or less. In contrast, the steels with the γ+θ temperature range of 100° C. or lower (our Examples) exhibit a small decrease in the hardness of the welding heat-affected zone and also have a narrower softening width.

TABLE 2

| | Residence time | | | | |
|---|---|---|---|---|---|
| | in γ + θ temperature | Hardness of most softened | Softening width of welding | Cementite | |
| | region during flash | part in welding heat- | heat-affected zone with | spheroidization rate of | |
| Steel | butt welding (s) | affected zone (HV) | 300 HV or less (mm) | most softened part (%) | Notes |
| A | 140 | 288 | 10 | 25 | Example |
| B | 140 | 291 | 10 | 25 | Example |
| C | 140 | 283 | 12 | 30 | Example |
| D | 140 | 275 | 14 | 33 | Example |
| E | 140 | 252 | 19 | 65 | Comparative Example |
| F | 140 | 255 | 22 | 65 | Comparative Example |
| G | 140 | 260 | 24 | 72 | Comparative Example |
| H | 140 | 293 | 12 | 35 | Example |
| I | 140 | 305 | 0 | 20 | Example |
| J | 140 | 296 | 7 | 36 | Example |
| K | 140 | 280 | 12 | 38 | Example |
| L | 140 | 289 | 15 | 41 | Example |

### Example 2

Using steel I, the welding conditions of the flash butt welding were varied to investigate the softening behavior of the weld. After straight flashing for 15 s and preheating for 50 s, the processing time of the final flashing was arbitrarily changed and about 20 mm upsetting was then carried out for an upset time of 10 s, followed by allowing to stand for 50 s and subsequent accelerated cooling. The integrated time from preheating to cooling start was defined as the residence time (s) in the γ+θ temperature region to investigate changes in the hardness characteristics of the welding heat-affected zone. The results are shown in Table 3. According to Table 3, the hardness of the most softened part tended to decrease and the softening width with 300 HV or less tended to increase as the residence time in the γ+θ temperature region was longer. The hardness of the most softened part significantly decreased and the softening width drastically increased particularly when the residence time in the γ+θ temperature region exceeded 200 s (Comparative Examples). This corresponds to a significant increase in the spheroidization rate of cementite. In contrast, the softening width and a decrease in the hardness of the most softened part in the welding heat-affected zone were small when the residence time in the γ+θ temperature region was 200 s or less (our Examples).

TABLE 3

| | Residence time | | | | |
|---|---|---|---|---|---|
| | in γ + θ temperature | Hardness of most softened | Softening width of welding | Cementite | |
| | region during flash | part in welding heat- | heat-affected zone with | spheroidization rate of | |
| Steel | butt welding (s) | affected zone (HV) | 300 HV or less (mm) | most softened part (%) | Notes |
| I | 60 | 333 | 0 | 16 | Example |
| I | 100 | 310 | 0 | 20 | Example |
| I | 140 | 305 | 0 | 20 | Example |
| I | 190 | 282 | 12 | 41 | Example |
| I | 230 | 263 | 18 | 55 | Comparative Example |

### Example 3

The hardness and changes in the strength characteristics of steels A, C, D, H, I, J, K, and L were investigated by varying the accelerated cooling conditions of cooling start and stop or the like after rail hot rolling. The results are shown in Table 4. As shown in Table 4, the hardness and strength of the rail surface (tensile strength, 0.2% yield strength) were not sufficient when the cooling start temperature was below 720° C., when the cooling rate was below 1° C./s, and when the cooling stop temperature was over 500° C. (Comparative Examples). In addition, the martensite was observed in part, and the elongation was low and the ductility decreased when the recovered temperature was 400° C. or lower (Comparative Examples). When the cooling start temperature, cooling rate, cooling stop temperature, and recovered temperature were within the specified values, high hardness rails were obtained which had a rail surface hardness of 370 HV or more, TS of 1300 MPa or more, 0.2% YS of 827 MPa or more, and EI of 10% or more (our Examples).

TABLE 4

| | Cooling | | Cooling | | Rail | | | | |
|---|---|---|---|---|---|---|---|---|---|
| | start | Cooling | stop | Recovered | head | 0.2% | | | |
| | temperature | rate | temperature | temperature | hardness | YS | TS | EI | |
| Steel | (° C.) | (° C./s) | (° C.) | (° C.) | (HV) | (MPa) | (MPa) | (%) | Notes |
| A | 750 | 2.6 | 420 | 480 | 378 | 876 | 1322 | 11.2 | Example |
| A | 700 | 3.2 | 400 | 450 | 355 | 780 | 1276 | 13.6 | Comparative |
| | | | | | | | | | Example |
| A | 740 | 6.2 | 220 | 360 | 412 | 893 | 1389 | 7.2 | Comparative |
| | | | | | | | | | Example |
| A | 760 | 4.3 | 330 | 420 | 398 | 911 | 1321 | 11.2 | Example |
| A | 750 | 0.8 | 370 | 420 | 342 | 762 | 1234 | 13.2 | Comparative |
| | | | | | | | | | Example |
| A | 760 | 3.5 | 580 | 630 | 333 | 750 | 1251 | 13.2 | Comparative |
| | | | | | | | | | Example |
| C | 750 | 3.2 | 370 | 450 | 416 | 989 | 1415 | 10.6 | Example |
| D | 760 | 2.8 | 380 | 450 | 410 | 930 | 1396 | 10.2 | Example |
| H | 770 | 3.3 | 360 | 440 | 422 | 976 | 1382 | 10.8 | Example |
| H | 760 | 4.8 | 260 | 360 | 435 | 889 | 1512 | 8.3 | Comparative |
| | | | | | | | | | Example |
| I | 740 | 2.8 | 370 | 420 | 452 | 1018 | 1489 | 10.9 | Example |
| J | 750 | 3.0 | 350 | 450 | 415 | 955 | 1382 | 11.0 | Example |
| K | 760 | 2.8 | 400 | 480 | 378 | 872 | 1342 | 11.8 | Example |
| L | 740 | 3.2 | 370 | 460 | 408 | 933 | 1403 | 10.7 | Example |

### Example 4

The hardness and tensile characteristics of steels A and H were investigated by varying the conditions of controlled rolling and subsequent accelerated cooling. The results are shown in Table 5. As shown in Table 5, the controlled rolling at a reduction of area of 20% or more at a temperature of 1,000° C. or lower allowed the steels to have substantially the same hardness and strength and to stably exhibit an elongation of 12% or more, showing more excellent ductility (our Examples). However, the cooling start temperature below 720° C., in contrast, reduced the hardness and strength to inhibit the wear resistance (Comparative Examples), which was an original object so that care was needed for decreased cooling start temperature due to excessive low-temperature rolling.

TABLE 5

| | Reduction | Roll | Cooling | | Cooling | | Rail | | | | |
|---|---|---|---|---|---|---|---|---|---|---|---|
| | of area at | finishing | start | Cooling | stop | Recovered | head | 0.2% | | | |
| | 1,000° c. | temperature | temperature | rate | temperature | temperature | hardness | YS | TS | EI | |
| Steel | or less (%) | (° C.) | (° C.) | (° C./s) | (° C.) | (° C.) | (HV) | (MPa) | (MPa) | (%) | Notes |
| A | 25 | 860 | 750 | 3.1 | 400 | 480 | 375 | 862 | 1322 | 12.5 | Example |
| A | 42 | 830 | 720 | 3.0 | 360 | 430 | 381 | 888 | 1351 | 13.3 | Example |
| A | 56 | 800 | 690 | 3.3 | 350 | 400 | 360 | 810 | 1283 | 14.5 | Comparative |
| | | | | | | | | | | | Example |
| H | 25 | 860 | 750 | 3.3 | 350 | 430 | 426 | 954 | 1389 | 12.2 | Example |
| H | 42 | 840 | 740 | 3.5 | 380 | 450 | 418 | 928 | 1367 | 13.3 | Example |
| H | 56 | 810 | 700 | 3.6 | 330 | 400 | 365 | 812 | 1218 | 14.5 | Comparative |
| | | | | | | | | | | | Example |

### INDUSTRIAL APPLICABILITY

Our rails and methods can be applied to a pearlite rail that has little softening in a welding heat-affected zone, high hardness, and high ductility, a flash butt welding method for a pearlite rail, and a method of manufacturing a pearlite rail.

1.-10. (canceled)

11. A pearlite rail comprising, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr by mass with the balance being Fe and inevitable impurities,
wherein a γ+θ temperature range is 100° C. or lower.

12. The pearlite rail according to claim 11, further comprising at least one of 0.01 to 1.0% Cu, 0.01 to 0.5% Ni, 0.01 to 0.5% Mo, 0.001 to 0.15% V, and 0.001 to 0.030% Nb with the balance being Fe and inevitable impurities,
wherein the γ+θ temperature range is 100° C. or lower.

13. A pearlite rail comprising, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr by mass with the balance being Fe and inevitable impurities,
wherein a γ+θ temperature range is 100° C. or lower, and
in a welding heat-affected zone formed by flash butt welding where a residence time in a γ+θ temperature region is 200 s or less, a softened part with a Vickers hardness of 300 HV or less has a width of 15 mm or less, and a most softened part has a hardness of 270 HV or more.

14. The pearlite rail according to claim 13, further comprising at least one of 0.01 to 1.0% Cu, 0.01 to 0.5% Ni, 0.01 to 0.5% Mo, 0.001 to 0.15% V, and 0.001 to 0.030% Nb with the balance being Fe and inevitable impurities,
wherein the γ+θ temperature range is 100° C. or lower, and
in a welding heat-affected zone during welding, a softened part with a Vickers hardness of 300 HV or less has a width of 15 mm or less, and a most softened part has a hardness of 270 HV or more.

15. The pearlite rail according to claim 11, wherein a proportion of a number of cementites with a ratio of a longer side to a shorter side (aspect ratio) of 5 or less is 50% or less based on a total cementite amount in a most softened part in a welding heat-affected zone.

16. A flash butt welding method for a pearlite rail, wherein, during upsetting and subsequent cooling in a flash butt welding of a pearlite rail, a residence time in a γ+θ temperature region is 200 s or less, a softened part of a welding heat-affected zone has a width of 15 mm or less, and a most softened part has a hardness of 270 HV or more.

17. A method of manufacturing a pearlite rail by hot rolling using a rail material having, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr by mass with the balance being Fe and inevitable impurities, wherein a γ+θ temperature range is 100° C. or lower, comprising:
starting accelerated cooling from a temperature of 720° C. or higher after hot rolling;
accelerating cooling at a cooling rate of 1° C./s to 10° C./s to reach 500° C. or lower; and
then allowing to cool to recover a temperature of a rail surface to 400° C. or higher.

18. A method of manufacturing a pearlite rail by hot rolling using a rail material having, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr by mass with the balance being Fe and inevitable impurities, wherein a γ+θ temperature range is 100° C. or lower, comprising:
performing hot rolling with a reduction of area of 20% or more at 1,000° C. or lower and with a roll finishing temperature of 800° C. or higher;
subsequently starting accelerated cooling from 720° C. or higher;
accelerating cooling at a cooling rate of 1° C./s to 10° C./s to reach 500° C. or lower; and
then allowing to cool to recover a temperature of a rail surface to 400° C. or higher.

19. The method according to claim 17, wherein the manufactured pearlite rail has a rail head surface with a hardness of 370 HV or more, a tensile strength of 1300 MPa or more, and a 0.2% yield strength of 827 MPa or more.

20. The method according to claim 18, wherein the manufactured pearlite rail has a rail head surface with a hardness of 370 HV or more, a tensile strength of 1300 MPa or more, a 0.2% yield strength of 827 MPa or more, and an elongation of 10% or more.

21. The pearlite rail according to claim 12, wherein a proportion of a number of cementites with a ratio of a longer side to a shorter side (aspect ratio) of 5 or less is 50% or less based on a total cementite amount in a most softened part in a welding heat-affected zone.

22. The pearlite rail according to claim 13, wherein a proportion of a number of cementites with a ratio of a longer side to a shorter side (aspect ratio) of 5 or less is 50% or less based on a total cementite amount in a most softened part in a welding heat-affected zone.

23. The pearlite rail according to claim 14, wherein a proportion of a number of cementites with a ratio of a longer side to a shorter side (aspect ratio) of 5 or less is 50% or less based on a total cementite amount in a most softened part in a welding heat-affected zone.

24. A method of manufacturing a pearlite rail by hot rolling using a rail material containing, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr, and at least one of 0.01 to 1.0% Cu, 0.01 to 0.5% Ni, 0.01 to 0.5% Mo, 0.001 to 0.15% V, and 0.001 to 0.030% Nb with the balance being Fe and inevitable impurities, wherein the γ+θ temperature range is 100° C. or lower, comprising:
starting accelerated cooling from a temperature of 720° C. or higher after hot rolling;
accelerating cooling at a cooling rate of 1° C./s to 10° C./s to reach 500° C. or lower; and
then allowing to cool to recover a temperature of a rail surface to 400° C. or higher.

25. A method of manufacturing a pearlite rail by hot rolling using a rail material containing, by % by mass, 0.70 to 1.0% C, 0.1 to 1.5% Si, 0.01 to 1.5% Mn, 0.001 to 0.035% P, 0.0005 to 0.030% S, and 0.1 to 2.0% Cr, and at least one of 0.01 to 1.0% Cu, 0.01 to 0.5% Ni, 0.01 to 0.5% Mo, 0.001 to 0.15% V, and 0.001 to 0.030% Nb with the balance being Fe and inevitable impurities, wherein the γ+θ temperature range is 100° C. or lower, comprising:
performing hot rolling with a reduction of area of 20% or more at 1,000° C. or lower and with a roll finishing temperature of 800° C. or higher;
subsequently starting accelerated cooling from 720° C. or higher;
accelerating cooling at a cooling rate of 1° C./s to 10° C./s to reach 500° C. or lower; and
then allowing to cool to recover a temperature of a rail surface to 400° C. or higher.

26. The method according to claim 24, wherein the manufactured pearlite rail has a rail head surface with a hardness of 370 HV or more, a tensile strength of 1300 MPa or more, and a 0.2% yield strength of 827 MPa or more.

27. The method according to claim 25, wherein the manufactured pearlite rail has a rail head surface with a hardness of 370 HV or more, a tensile strength of 1300 MPa or more, a 0.2% yield strength of 827 MPa or more, and an elongation of 10% or more.
